(19) United States
(12) Patent Application Publication
(10) Pub. No.: US 2017/0076635 A1
(43) Pub. Date: Mar. 16, 2017

(54) VASCULAR PROCEDURE TRAINING SYSTEM

(71) Applicant: Steve Homich, Greenville, MI (US)

(72) Inventor: Steve Homich, Greenville, MI (US)

(73) Assignee: Gray's Bone and Joint Models, LLC, Greenville, MI (US)

(21) Appl. No.: 15/203,107

(22) Filed: Jul. 6, 2016

Related U.S. Application Data
(60) Provisional application No. 62/188,961, filed on Jul. 6, 2015.

(51) Int. Cl. G09B 23/30; G09B 9/00

(52) U.S. Cl. CPC G09B 23/303; G09B 9/00

(57) ABSTRACT

A vascular procedure training system includes a trainer designed to replicate a portion of a human limb, such as a leg of a human. The trainer includes one or more replicate bones, a plurality of arteries connected to the one or more bones and having at least one blockage therein, and a flesh substance formed over the one or more bones and plurality of arteries in the shape of the replica human limb. A fluid pump is connected to at least one of the plurality of arteries and configured to pump a fluid through the plurality of arteries.

### CROSS-REFERENCE TO RELATED APPLICATIONS

This application claims the benefit of U.S. Provisional Patent Application Ser. No. 62/188,961 filed Jul. 6, 2015 and entitled “VASCULAR PROCEDURE TRAINING SYSTEM,” which is hereby incorporated by reference in its entirety.

### FIELD OF INVENTION

The present invention generally relates to a medical training device and system for teaching surgical procedures on the human body and specifically related to the vascular system.

### BACKGROUND

Vascular occlusions, or blood vessel clots and blockages, are a common problem, specifically in people with various health conditions. Occlusions are very dangerous and in many situations can even be fatal if not properly treated and removed. Recently, new methods have been developed for treating such occlusions. These methods include procedures that are conducted within the body under x-ray or ultrasound guidance.

One common problem with teaching and refining such new procedures is that it is difficult for surgeons to practice the new techniques before implementing them on live patients. Currently, the only form of practice that surgeons have is by using cadavers. However, there are many problems and drawbacks associated with the use of cadavers for refining these surgical methods.

One first problem is availability and cost. Cadavers come at a substantial cost, sometimes upwards of $1000/day for use and may be prohibitively expensive to purchase. Cadavers also may be difficult to obtain. Scheduling availability for cadavers, especially large numbers of cadavers, in advance can be difficult.

Cadavers also do not provide any assurances as to the conditions that may be present. When attempting to teach a procedure on treating occlusions, it is necessary that such occlusions be present in the cadaver. However, often only a small percentage of the cadavers in use in a training session will actually have an occlusion. And those that do have occlusions often don't have enough pressure in the system to provide any flashing or feedback once the artery is pierced, and therefore do not provide the real world feel that a surgeon will have when conducting the procedure.

Finally, cadavers are limited in how many times they may be used for practicing a procedure. Techniques for treating occlusions often begin by inserting a needle into the flesh to and into an artery. Most entry sites on a cadaver will become worn and unusable after as little as 2-3 uses.

Accordingly, an improved trainer for occlusion procedures is needed.

### SUMMARY

A vascular procedure training system is generally provided. The vascular procedure training system includes a trainer designed to replicate a portion of a human limb, such as a leg of a human. The trainer includes one or more replicate bones formed out of an appropriate material, such as a mixture of Neukadur Multicast 1 and Aluminum-Hydroxide, to replicate the hardness of a human bone. The trainer further includes a plurality of arteries connected to the one or more bones, the arteries comprising tubular lengths. At least one of the arteries includes a blockage therein to replicate a blockage in a human artery. A flesh substance is formed over the one or more bones and plurality of arteries in the shape of the replica human limb, wherein the flesh substance is formed of a material that is softer and more penetrable than the material of the bones.

The vascular procedure training system further includes a fluid pump connected to at least one of the plurality of arteries. The fluid pump is configured to pump a fluid through the plurality of arteries. A pressure regulator may be connected to the fluid pump to regulate the flow of fluid pressure within the arteries. The fluid pump may be a sump pump having a reservoir.

In an embodiment, a method of making a vascular procedure training system includes providing a plurality of tubular lengths arranged to replicate the artery structure within a portion of a human limb, such as a portion of a human leg. Blockages are placed within at least one of the plurality of tubular lengths to replicate artery blockages. One or more replicate bones are provided and arranged to replicate bones in the portion of the human limb. The plurality of tubular lengths are connected to the one or more of replicate bones. The plurality of tubular lengths and the one or more bones are arranged within a mold and the mold is filled with a replicate flesh substance to surround the plurality of tubular lengths and the one or more bones. The mold is configured to form the flesh substance in the form and shape of the human limb. At least one of the plurality of tubes is connected to a fluid pump. The fluid pump is configured to pump a fluid through the plurality of tubular lengths.

### BRIEF DESCRIPTION OF THE DRAWINGS

The operation of the invention may be better understood by reference to the detailed description taken in connection with the following illustrations, wherein:

FIG. 1 illustrates an overview of a vascular procedure training system;

FIG. 2 illustrates the artery and vein system of a vascular procedure training system;

FIG. 3 illustrates a detailed view of a vascular procedure training system having a removable cartridge;

FIG. 4 illustrates a perspective view of a vascular procedure training system having a removable cartridge; and

FIG. 5A illustrates a clean artery;

FIG. 5B illustrates a partially blocked artery;

FIG. 5C illustrates a completely blocked artery;

FIG. 6 illustrates an ultrasound monitoring system; and

FIG. 7 illustrates a modified pedal access needle.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

A vascular procedure training system 10 is generally presented. The vascular procedure training system 10 is generally configured provide a training mechanism for surgeons to practice vascular procedures.

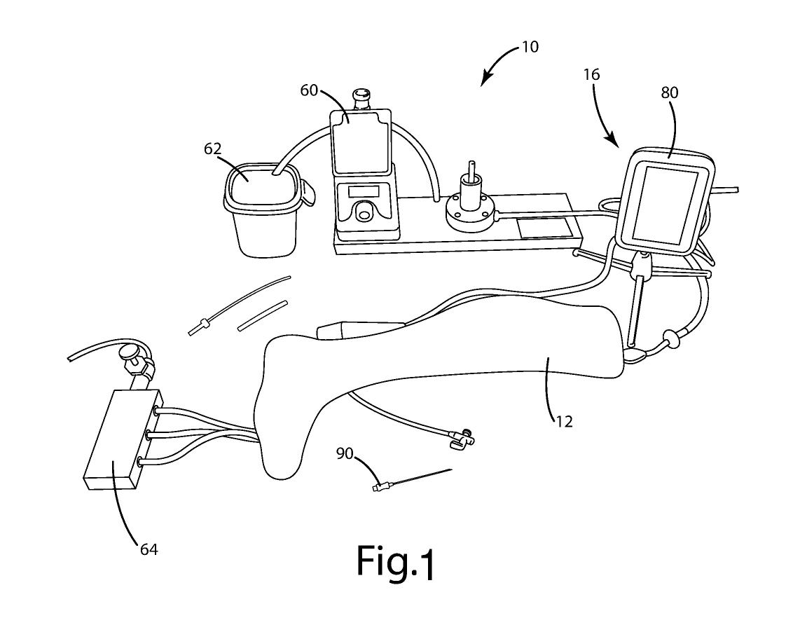

As illustrated in FIG. 1, the vascular procedure training system (“training system”) 10 may comprise various components, including a trainer 12 a pump system 14, and an ultrasound system 16. The training system 10 may include any combinations of these components or variations thereto. While each of these portions of the training system 10 are described below, it will be appreciated that other components may also be added into the system to alter the functionality, based on the procedure to be performed.

The training system may 10 may include a trainer 12 to allow surgeons to practice various surgical procedures, such as vascular surgical procedures, without the need for a cadaver. The trainer 12 may comprise an artificial or synthetic portion of the human body that includes the necessary internal body parts, such as arteries and veins, to practice and perform a desired procedure. In an embodiment, the trainer 12 may comprise a portion of a leg, as illustrated in FIG. 1. However, the trainer 12 may comprise any portion or portions of the human body as may be necessary for practicing a given procedure.

The trainer 12 may be generally made up of any appropriate material necessary to replicate human skin, flesh, bones, muscles, arteries, veins, and other structures in the human body. The trainer may be sized to fit the accepted dimensions of the human skeleton of a Caucasian male of 180 cm in height.

In an embodiment, the flesh portions 18 of the trainer 12 may be made up primarily of silicone. The silicone may be specifically designed to have the look at feel of human skin and flesh, including color and firmness of flesh. The flesh portions 18 may be penetrable by a needle. The silicon may be specifically designed to allow ultrasound scanning of the trainer 12 through the flesh portions 18 into the internal parts of the trainer 12.

The trainer 12 may include one or more bones, appropriate for the body part replicated by the trainer 12. For example, the leg trainer may include a tibia 20 and fibula 22 and any appropriate foot bones 24. The tibia 20 and fibula 22 may be formed by a molding process. In an embodiment, the bones may be formed of a mixture of Neukadur Multicast 1 and Aluminum-Hydroxide. The material may be mixed at a specific ratio, such as 180 grams of Neukadur Multicast 1 and 400 grams of Aluminum-Hydroxide to produce the tibia, and 60 grams of Neukadur Multicast 1 and 90 grams of Aluminum-Hydroxide to produce the fibula. The foot bones 24 may be produced using similar materials as well, such as 150 grams of Neukadur Multicast 1 and 200 grams of Aluminum-Hydroxide to produce the tibia.

In addition to the tibia 20, fibula 22 and foot bones 24, the trainer 12 may include other bones, such as a patella 26 and femur 27. Each of the bones may be glued together to hold them in the anatomically appropriate configuration.

It will be appreciated that, in order to maintain anatomical accuracy and using the materials described above, the skin and flesh portions of the trainer 12 will be much softer and penetrable than the harder and less penetrable tibia 20, fibula 22, and foot bones 24.

The trainer 12 may include an anatomically correct configuration of arteries and veins to allow for practicing a vascular procedure. The arteries and veins may be generally tubular and shaped and sized to replicate human arteries and veins. In an embodiment the arteries and veins may be made of hot-extruded silicon tube. The veins and arteries may be color coded to distinguish one from the other. For example, the arteries may be made of red silicon tube and the veins may be made of blue silicon tube. The arteries and veins may be fixed to the bones, using any appropriate glue or epoxy. The arteries may include connection points 28 as necessary to interconnect the tubing.

In an embodiment, the arteries may be positioned and assembled on the trainer 12 in a specified order. The arteries and veins may be connected to the bones as described below and placed into tooling. The tooling may then be filled with composite material of silicon rubber, silicon oil, and cellulose, to mold the trainer 12. The process will both mold the trainer 12 and fix the arteries and veins in their anatomically correct position. After the trainer 12 has hardened, a skin layer comprised of silicon rubber may be applied to the leg trainer 12.

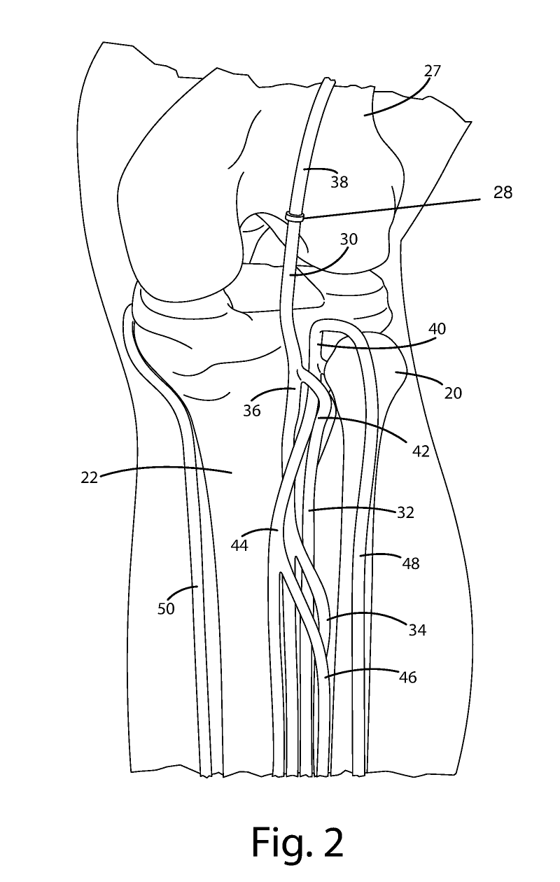

The arteries may be configured in a similar arrangement to the arteries in the human body. As illustrated in FIG. 2, a leg trainer 12 may include the following arteries: popliteal artery 30, anterior tibial artery 32, peroneal artery 34, posterior tibial artery 36, femoral artery 38. Each artery may be positioned to be consistent with the corresponding appropriate location in the human body. The arteries may interconnect and split flow paths in the same manner as in the human body. The arteries may extend to each end of the trainer 12 to allow flow in and out of the trainer 12.

The popliteal artery 30 may have a length of 100 millimeters (“mm”), an outer diameter of 60 mm, and inner diameter of 40 mm. The popliteal artery may be connected to the top of the rear side of the tibia 20, and extend down 100 mm along the tibia 20 approximately 10 mm distance from the tibia 20 up to the first branching point, as seen in FIG. 2.

The anterior tibial artery 32 branches off of the popliteal artery 30 beneath and between the upper junction of the tibia 20 and the fibula 22. The anterior tibial artery 32 is located between the tibia 20 and the fibula 22 and extends toward the upper part of the foot. The length of the anterior tibial artery 32 measured from the branching point at the popliteal artery 30 to the foot is 400 mm. The anterior tibial artery 32 exits the trainer 12 through the foot and includes a length of tube, approximately 350 mm.

The peroneal artery 34 branches off the popliteal artery 30 and extends parallel to the fibula 22, maintaining a 10 mm distance away from the fibula 22. The peroneal artery 34 is approximately 370 mm, measured from the branching point to the top of the heel bone. The peroneal artery 34 then continues along the sole of the foot bones alongside the side of the heel bone. The peroneal artery 34 exits the trainer 12 through the end of the foot with a 350 mm long open tube.

The posterior tibial artery 36 branches off the popliteal artery 30 toward a first side of the tibia 20 and extends toward the opposite side of the heel bone. The length of the posterior tibia artery 36 measured from the branching spot at the popliteal artery 30 to the top of the heel bone is 370 mm. The terminal end of the posterior tibial artery 36 continues on the side of the heel bone, extending along the surface of the sole 100 mm long towards the inner side of the foot, and exits the trainer 12 through the end of the foot with a 350 mm long open tube.

The trainer 12 may include anatomically correct representations of the veins in the portion of the human body replicated by the trainer. As illustrated in FIG. 2, a leg trainer 12 may include the following veins: popliteal vein 40, anterior tibial vein 42, posterior tibial vein 44, peroneal vein 46, lesser saphenous vein 48, great saphenous vein 50.

The popliteal vein 40 may extend from the top of the rear side of the tibia 20 down 100 mm along the tibia 20, approximately 10 mm away from the tibia 20 until the first branching. The popliteal vein 40 may then branch into two sections, described below.

A first branching off the popliteal vein 20 is called the anterior tibial vein 42. The anterior tibial vein 42 begins at a junction beneath and between the upper junction of the tibia 20 and the fibula 22. The anterior tibial vein 42 extends approximately 400 mm down until it reaches the foot.

The posterior tibial vein 44 branches off of the end of the popliteal vein 40 and extends approximately 370 mm to the heel bone. The peroneal vein branches 46 also branches off the end of the poplietal vein 40 and extends, parallel to the fibula 22, approximately 370 mm downwards up to the top of the heel bone. The peroneal vein 46 ends in a closed tube.

The small saphenous vein 48 begins on the back side of the top of the fibula 22 and follows the curved shape of the trainer 12 for approximately 480 mm. The small saphenous vein 48 ends in a closed tube end on the side of the heel bone. The great saphenous vein 50 begins on the front side of the top of the fibula 22 and follows the fibula 22 towards the foot for approximately 430 mm where it ends in a closed tube.

It will be appreciated that the trainer 12 may include any appropriate arteries and veins, as well as other internal organs, bones, muscles, and other internal body parts, as may be necessary to represent the body part replicated by the trainer 12.

The vascular procedure training system 10 may be configured to drive a fluid flow through the arteries in the trainer 12 to simulate the flow of blood within the body. As shown in FIG. 1, the system 10 may include a pump system 14. The pump system 14 may include a fluid pump 60, configured to pump fluid through the arteries. The fluid may be any appropriate fluid, such as water or synthetic blood.

In an embodiment, the pump 60 may be configurable to vary and control the pressure of the fluid within the arteries. The variable fluid pressures provide varying internal pressures within the arteries to alter the force needed to pierce each artery.

The pump 60 may drive liquid directly into any of the arteries that are extending out of the trainer 12. For example, in the leg trainer, the pump 60 may drive liquid directly into and through the popliteal artery 30. The flow may split off into the subsequent arteries at each appropriate branching point to create liquid flow through all of the arteries. The liquid flow may exit from the trainer 12 at the foot, through the anterior tibial artery 32, peroneal artery 34, and posterior tibial artery 36.

The veins may be used primarily to represent correct anatomical structure of the trainer 12 and may be free from any fluid flow. Alternatively, in an embodiment, the veins may be used to facilitate return flow of the liquid from the arteries to the pump 60. The veins may connect to the anterior tibial arter 32, peroneal artery 34, and posterior tibial artery 36 at the end of the foot and return the flow of fluid back to the pump 60.

In an embodiment, the pump system 14 may have a sump configuration. The fluid from the arteries may flow out of the trainer 12 and routed to a reservoir 62. The pump 60 may then pull liquid from the reservoir 62 to pump through the trainer 12. The pump system 14 may further include a pressure regulator 64. The pressure regulator 64 may be connected inline with the arteries or return lines to the reservoir 62 at any appropriate location. The pressure regulator 64 may include a valve or adjustment to vary the pressure or flow within the arteries. The flow adjustment may allow users to alter the amount of feedback or flash they experience when piercing an artery. In an embodiment, the pressure regulator 64 may receive a plurality of arteries and output a single flow line to the reservoir 62.

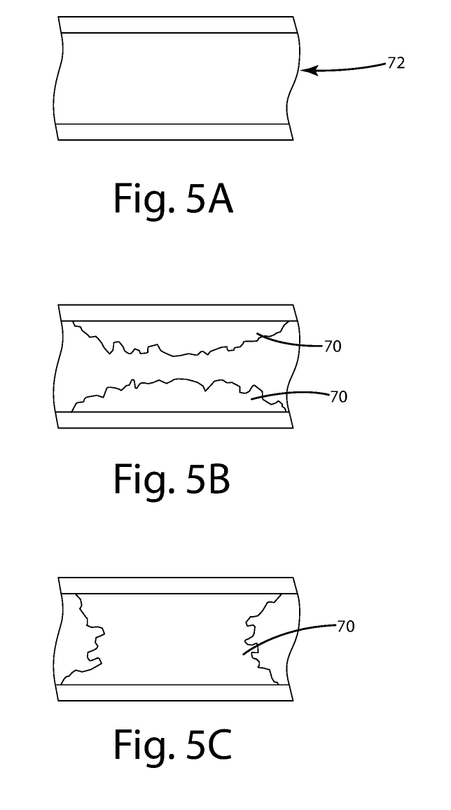

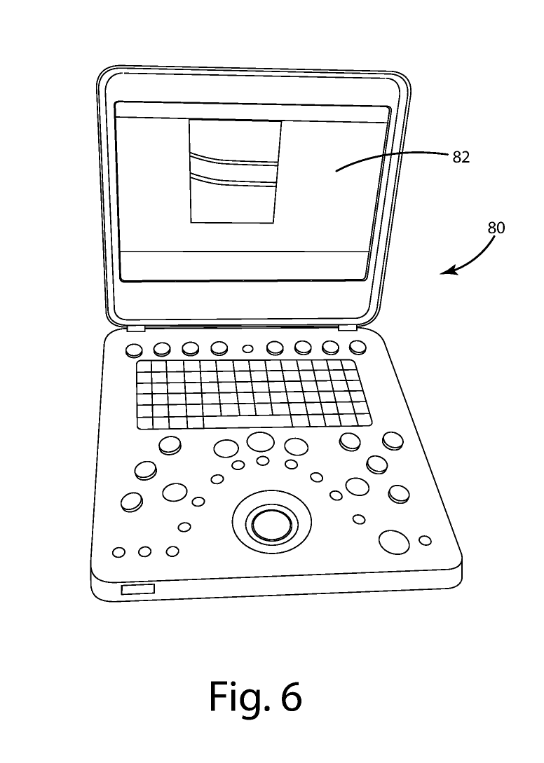

The trainer 12 may include one or more occlusions or blockages 70 in the arteries. The arteries may be specifically configured to include different types of occlusions 70 in order to provide a means for practicing different procedures. FIG. 5A illustrates an artery 72 having no occlusions 70. FIG. 5B illustrates an artery having a partial or 70% occlusion 70. And FIG. 5C illustrates an artery having a complete or 100% occlusion 70. The trainer 12 may include different occlusions 70 placed at different locations in the arteries.

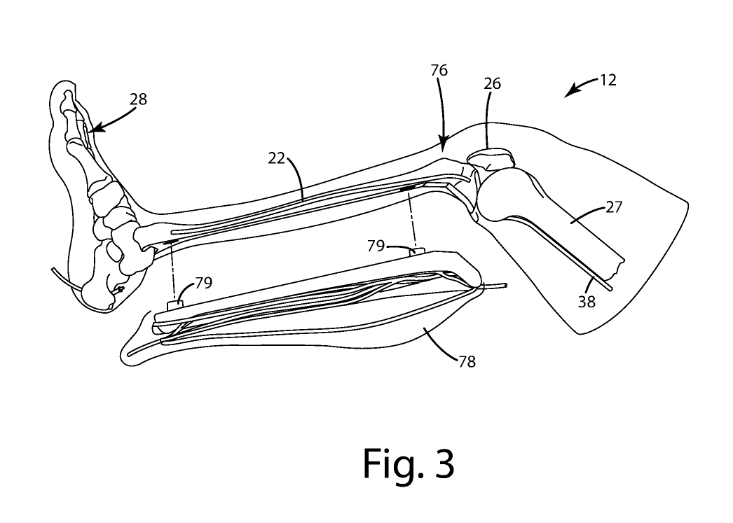

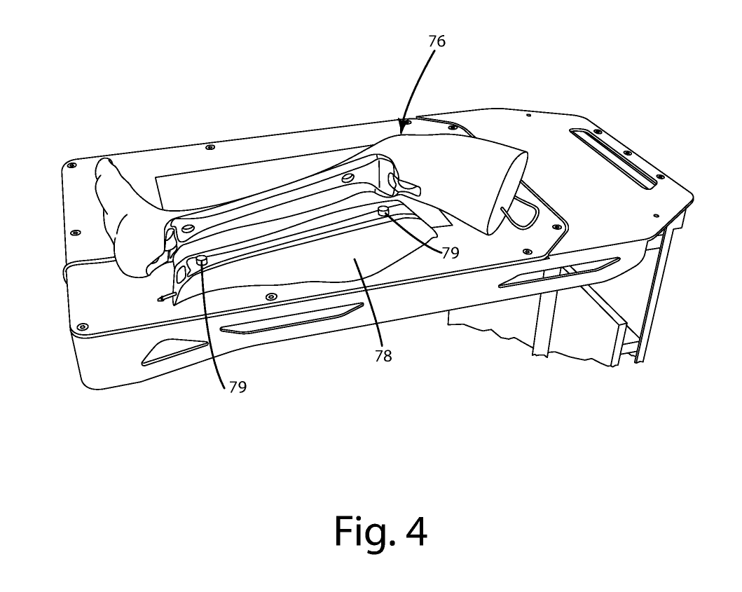

In an embodiment, the trainer 12 may be divided into two or more portions, as shown in FIGS. 3 and 4. A first portion may comprise the trainer base 76. The trainer base 76 may include outer portions of the trainer 12 that are not commonly operated on during a vascular procedure. The trainer may further include one or more cartridges 78. The cartridges 78 may be connectable to the trainer base 76. The cartridges 78 may include the arteries and veins described above, or portions thereof. The cartridge or cartridges 78 may be removable from the trainer base 76 and replaceable once it becomes worn or depleted through too much use. The cartridge 78 may include one or more pins 79 to connect the cartridge 78 to the trainer base 76 such that the artery and vein portions in the cartridge 78 align with the same arteries and veins in the trainer base and ensure proper flow through the trainer 12.

The vascular procedure training system 10 may include an ultrasound device 80. The ultrasound device 80 may include a scanner to read the flow of fluid within the arteries and detect whether flow is normal or the existence of an occlusion. The ultrasound device 80 may include a read out 82 to provide ultrasound data to the user. The ultrasound device 80 may further be used in conducting a procedure to locate an artery and provide visual feedback on the location of instruments used in the procedure.

In use, the ultrasound device 80 may be used to detect the existence of an occlusion 70 within an artery in the trainer 12. A surgeon may then use a needle, such as a pedal access needle, to make an incision into the trainer near the site of the occlusion. The pedal access needle may be inserted all the way into the artery. A guide wire may then be inserted through the opening in the pedal access needle, and a catheter may be positioned over the guide wire. The occlusion 70 may be removed, and each item then removed from the artery and from the trainer 12.

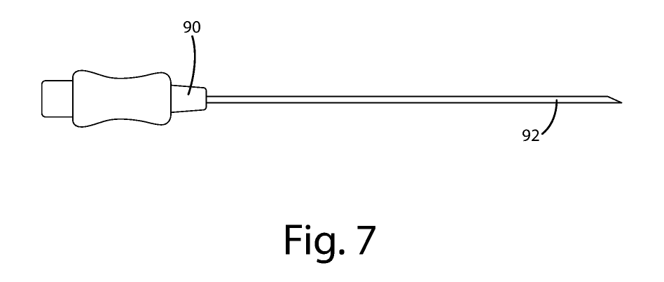

In an embodiment, as shown in FIG. 7, the pedal access needle 90 may be modified to provide visual enhancement when used with the ultrasound device 80. For example, the pedal access needle 90 may include very small threads or scoring lines 92 cut into the outer surface of the needle. The threads or lines 92 may allow the needle 90 to be picked up better by the ultrasound device 80 and thus provide a more clear representation of the needle 90 on the read out 82.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, we claim:

1. A vascular procedure training system comprising:
a trainer comprising a replica of at least a portion of a human limb, wherein the trainer includes:
one or more bones composed of a first material;
a plurality of arteries connected to the one or more bones, the arteries comprising tubular lengths, wherein at least one of the arteries includes a blockage therein;
a flesh substance formed over the one or more bones and plurality of arteries in the shape of the replica human limb, wherein the flesh substance is formed of a second material that is softer and more penetrable than the first material;
a fluid pump system connected to at least one of the plurality of arteries, wherein the pump system is configured to pump a fluid through the plurality of arteries.

2. The vascular procedure training system of claim 1, wherein the replica of at least a portion of a human limb is a replica human leg.

3. The vascular procedure training system of claim 1, wherein the one or more bones includes replicas of a human tibia and fibula.

4. The vascular procedure training system of claim 1, wherein the one or more bones are formed of a mixture of Neukadur Multicast 1 and Aluminum-Hydroxide.

5. The vascular procedure training system of claim 1 further including a plurality of veins connected to the one or more bones, the veins comprising tubular lengths, and wherein the flesh substance is formed over the arteries, veins, and one or more bones.

6. The vascular procedure training system of claim 5, wherein veins are connected to the fluid pump and configured to receive fluid flowing in an opposite direction of the flow of fluid through the arteries.

7. The vascular procedure training system of claim 1, wherein the arteries are arranged to duplicate the artery structure in a human leg, including at least one of the popliteal artery, anterior tibial artery, peroneal artery, posterior tibial artery, and femoral artery.

8. The vascular procedure training system of claim 1, wherein the flesh substance is comprised of silicon rubber, silicon oil, and cellulose.

9. The vascular procedure training system of claim 1, wherein the fluid pump is a sump pump having a reservoir.

10. The vascular procedure training system of claim 1, further comprising a pressure regulator positioned in line with the plurality of arteries and the fluid pump to regulate the fluid pressure within the arteries.

11. The vascular procedure training system of claim 1, wherein the fluid pump is configured to pump liquid into training system through the replica of the popliteal artery.

12. The vascular procedure training system of claim 1, wherein fluid is configured to exit the training system through the replica of the anterior tibial artery.

13. The vascular procedure training system of claim 1, further comprising an ultrasound unit configured to examine the arteries to locate the blockage.

14. The vascular procedure training system of claim 1, further comprising a pedal access needle configured to penetrate the flesh substance to access the blockage, wherein the pedal access needle includes a plurality of scoring lines cut into its outer surface.

15. A method of making a vascular procedure training system comprising:
providing a plurality of tubular lengths arranged to replicate the artery structure within a portion of a human limb;
placing a blockage within at least one of the plurality of tubular lengths;
providing one or more replicate bones arranged to replicate bones in the portion of the human limb;
connecting the plurality of tubular lengths to the one or more of replicate bones;
arranging the plurality of tubular lengths and the one or more bones within a mold and filling the mold with a replicate flesh substance to surround the plurality of tubular lengths and the one or more bones, wherein the mold is configured to form the flesh substance in the form and shape of the human limb;
connecting at least one of the plurality of tubes to a fluid pump, wherein the fluid pump is configured to pump a fluid through the plurality of tubular lengths.

16. The method of making a vascular procedure training system of claim 15, further comprising connecting a pressure regulator in line with at least one of the plurality of tubular lengths.

17. The method of making a vascular procedure training system of claim 15 further comprising forming the replicate bones out of a mixture of Neukadur Multicast 1 and Aluminum-Hydroxide.

18. The method of making a vascular procedure training system of claim 15, wherein the flesh substance is comprised of silicon rubber, silicon oil, and cellulose.

19. The method of making a vascular procedure training system of claim 15 further comprising applying a skin layer of silicon rubber to the molded replicate human limb.

20. The method of making a vascular procedure training system of claim 15, wherein the human limb is a portion of a leg, and further wherein the one or more replicate bones comprise a tibia and fibula.
